(19) United States
(12) Patent Application Publication
(10) Pub. No.: US 2019/0166457 A1
(43) Pub. Date: May 30, 2019

(54) SYSTEMS AND METHODS FOR LOCATION-BASED ALERT GENERATION

(71) Applicant: Pelmorex Corp., Oakville (CA)

(72) Inventors: Naomi Lipowski, Toronto (CA); Marc Morrissette, Toronto (CA); Mathieu Bruyere, Etobicoke (CA); Bryanna Lynn O'Neill, Caistor Centre (CA); Jean-Frédéric Gaudreault, Milton (CA); Matthew Reid Ward Smith, Richmond (CA); Farjaad Waris Rawasia, Oakville (CA); Yufei Yang, Waterloo (CA)

(21) Appl. No.: 16/200,771

(22) Filed: Nov. 27, 2018

Related U.S. Application Data
(60) Provisional application No. 62/590,872, filed on Nov. 27, 2017.

(51) Int. Cl. H04W 4/021; H04W 4/029; H04W 4/20

(52) U.S. Cl. CPC H04W 4/022; H04W 4/20; H04W 4/029

(57) ABSTRACT

System and method for generating location-based alerts. An alert generation server communicates with official alert systems and a plurality of mobile devices operating a mobile alert application. The alert generation server receives alert data from the official alert systems and defines a plurality of alert events by extracting corresponding alert location information and assigning official alert types to the alerts in the received official alert data. The alert generation server also receives user-generated alert data defining alert events identified by mobile device users. The user-generated alert data is used to update and/or modify the defined alert events. Each alert event has a geographic region code corresponding to extracted alert location information. The mobile alert application determines, based on mobile device location data that the mobile device is within the geographic region of an alert event and generates an alert notification for that mobile device.

### CROSS-REFERENCE TO RELATED APPLICATION

This application claims priority to U.S. Provisional Application No. 62/590,872 filed on Nov. 27, 2017, the entire contents of which are hereby incorporated herein by reference.

### TECHNICAL FIELD

The present disclosure relates generally to generating real-time alerts, and in particular to systems and methods for generating location-based alerts for mobile device users.

### INTRODUCTION

The following is intended to introduce the reader to the detailed description that follows and not to define or limit the claimed subject matter.

Recently, severe weather events have been occurring with increased frequency. In 2016, hurricane events occurred over the longest period since 1951. These hurricane events spanned the second longest hurricane season on record.

Similarly, health outbreak events such as epidemic events appear to be increasing in regularity. Over the past 60 years, the number of new diseases identified each decade has nearly quadrupled. The number of health outbreak events each year has also more than tripled since 1980.

Various systems exist to track events, such as weather events and health outbreak events. These systems typically track a single type of event, e.g., a weather tracking system or a health monitoring system. When an event is detected, these systems may post a notification on their website or perhaps through media channels such as television or radio. As a result, an individual looking for information on events occurring in their vicinity often has to navigate through numerous different event monitoring systems, and through the various notifications provided by those systems, to identify potentially relevant information.

In an aspect of the present disclosure, there is provided a system for generating location-based alerts for mobile device users. The system can include an alert generation server in communication with a plurality of official alert systems, the plurality of official alert systems including a plurality of independent alert systems that each monitor one or more types of alert events, and a plurality of mobile devices in communication with the alert generation server, each mobile device having a mobile alert application operating thereon. The alert generation server can be configured to receive official alert data from the plurality of official alert systems, the official alert data defining a plurality of official alerts; extract, for each official alert, corresponding alert location information from the received official alert data; generate an official alert geographic location code for each official alert based on the extracted alert location information; assign each official alert an official alert type based on the received official alert data, the official alert type defining the type of event indicated by that official alert; define a plurality of alert events based on the plurality of official alerts using the assigned official alert type and official alert geographic location code generated for each official alert, where each alert event has a defined event alert type that corresponds to the official alert type for one or more of the official alerts and a geographic region code that defines a geographic region for the alert event that includes the location identified by the official alert geographic location code for the one or more official alerts, and at least one of the mobile devices can be configured by the mobile alert application operating thereon to determine, based on location data from that mobile device, that the mobile device is located within a threshold proximity of the geographic region defined by one of the alert events; and generate an alert notification for a user of that mobile device, the alert notification identifying the alert event and providing an indication that the mobile device is within the threshold proximity of the geographic region of that alert event.

In some embodiments, the alert generation server can be configured to receive user-generated alert data from the mobile alert application operating on a particular mobile device in the plurality of mobile devices, the user-generated alert data including a user-generated alert type and alert location data, define a user-alert geographic location code for the user-generated alert data based on the alert location data, and define the plurality of alert events using the received user-generated alert data, where the alert type defined by the alert generation server for one of the alert events corresponds to the user-generated alert type and the geographic code defined by the alert generation server for the one of the alert events defines a geographic region including the location indicated by the user-alert geographic location code.

In some embodiments, the alert generation server can be configured to correlate the user-generated alert data with the official alert data by: comparing the user alert geographic location code with the official alert geographic location codes generated for each of the official alerts, and comparing the user-generated alert type with the official alert type assigned to each of the official alerts; to determine, based on the correlation, that the user-generated alert data corresponds to an additional alert event; and to define the plurality of alert events to include an additional alert event using the user-generated alert type and user alert geographic location code, where the additional alert event has a defined event alert type that corresponds to the user-generated alert type and a geographic region code that defines a geographic region for the additional alert event that includes the location identified by the user alert geographic location code.

In some embodiments, the alert generation server can be configured to correlate the user-generated alert data with the official alert data by: comparing the user alert geographic location code with the official alert geographic location codes generated for each of the official alerts, and comparing the user-generated alert type with the official alert type assigned to each of the official alerts; to determine, based on the correlation, that the user-generated alert data corresponds to a particular alert event in the plurality of alert events; and to update the definition of the particular alert event to include the user alert geographic location code and the user-generated alert type.

In some embodiments, the particular mobile device can be configured by the mobile alert application operating thereon to define a user input interface on the mobile device that includes a plurality of pre-defined alert types; receive a user input selecting one of the pre-defined alert types; and define the user-generated alert type as the selected pre-defined alert type.

In some embodiments, the particular mobile device can be configured by the mobile alert application operating thereon to receive an alert generation input indicating the creation of the user-generated alert data; and automatically generate the alert location data in response to the alert generation input by identifying mobile device location data defining a current location of the mobile device.

In some embodiments, the alert generation server can be configured to receive user-generated alert data from the mobile alert application operating on a plurality of additional mobile devices, the user-generated alert data from each additional mobile device including a corresponding user-generated alert type and corresponding alert location data; determine that the user-generated alert data received from at least one of the additional mobile devices relates to the same alert event as the user-generated alert data received from the particular mobile device; determine that the user-generated alert data received from the at least one of the additional mobile devices includes alert location data identifying a location external to the geographic region defined by the geographic region code of that alert event; and modify the geographic region code of that alert event to include the location defined by the alert location data received from the at least one of the additional mobile devices.

In some embodiments, the alert generation server can be configured to receive user-generated alert data from the mobile alert application operating on a specific mobile device, where the user-generated alert data includes user-generated alert media captured by the mobile device; and associate the user-generated alert media with the alert event related to that received user-generated alert data; and the at least one mobile device can be configured by the mobile alert application operating thereon to generate the alert notification to include a user-generated media prompt, the user-generated media prompt enabling a user of the at least one mobile device to initiate playback of the user-generated alert media associated with that alert event.

In some embodiments, the at least one mobile device can be configured by the mobile alert application operating thereon to generate the alert notification to include a user-generated data prompt, the user-generated data prompt enabling a user of the at least one mobile device to input user-generated alert data related to the one of the alert events.

In some embodiments, the at least one mobile device can be configured by the mobile alert application operating thereon to generate the alert notification to include a user feedback prompt, the user feedback prompt enabling a user of the at least one mobile device to input an alert score indicating an accuracy of the alert notification; and transmit the alert score to the alert generation server; and the alert generation server can be configured to update the definition of the one of the alert events in response to receiving the alert score.

In some embodiments, the alert generation server can be configured to, for each of at least one of the official alerts extract alert location information from the received official alert data by determining that the official alert data received from the official alert system corresponding to that official alert includes text data describing an associated alert location; and extracting the identified text data; and to generate the official alert geographic location code by correlating the extracted text data with a corresponding geo-code.

In another aspect of the present disclosure there is provided a method of generating location-based alerts for mobile device users using an alert generation server in communication with a plurality of official alert systems each monitoring one or more types of alert events. The method can include providing a mobile alert application to a plurality of mobile devices in communication with the alert generation server; receiving, by the alert generation server, official alert data from the plurality of official alert systems, the official alert data defining a plurality of official alerts; extracting, by the alert generation server for each official alert, corresponding alert location information from the received official alert data; generating, by the alert generation server, an official alert geographic location code for each official alert based on the extracted alert location information; assigning, by the alert generation server, each official alert an official alert type based on the received official alert data, the official alert type defining the type of event indicated by that official alert; defining, by the alert generation server, a plurality of alert events based on the plurality of official alerts using the assigned official alert type and official alert geographic location code generated for each official alert, where each alert event has a defined event alert type that corresponds to the official alert type for one or more of the official alerts and a geographic region code that defines a geographic region for the alert event that includes the location identified by the official alert geographic location code for the one or more official alerts; determining, by the mobile alert application operating on one of the mobile devices based on location data from that mobile device, that the mobile device is located within a threshold proximity of the geographic region defined by one of the alert events; and generating, by the mobile alert application operating on that mobile device, an alert notification for a user of that mobile device, the alert notification identifying the alert event and providing an indication that the mobile device is within the threshold proximity of the geographic region of that alert event.

In some embodiments, the method may include receiving, by the alert generation server, user-generated alert data from the mobile alert application operating on a particular mobile device in the plurality of mobile devices, the user-generated alert data including a user-generated alert type and alert location data; defining, by the alert generation server, a user-alert geographic location code for the user-generated alert data based on the alert location data; and defining, by the alert generation server, the plurality of alert events using the received user-generated alert data, where the alert type defined by the alert generation server for one of the alert events corresponds to the user-generated alert type and the geographic code defined by the alert generation server for the one of the alert events defines a geographic region including the location indicated by the user-alert geographic location code.

In some embodiments, the method may include correlating, by the alert generation server, the user-generated alert data with the official alert data by: comparing the user alert geographic location code with the official alert geographic location codes generated for each of the official alerts, and comparing the user-generated alert type with the official alert type assigned to each of the official alerts; determining, by the alert generation server based on the correlation, that the user-generated alert data corresponds to an additional alert event; and defining, by the alert generation server, the plurality of alert events to include an additional alert event using the user-generated alert type and user alert geographic location code, where the additional alert event has a defined event alert type that corresponds to the user-generated alert type and a geographic region code that defines a geographic region for the additional alert event that includes the location identified by the user alert geographic location code.

In some embodiments, the method may include correlating, by the alert generation server, the user-generated alert data with the official alert data by: the user alert geographic location code with the official alert geographic location codes generated for each of the official alerts, and comparing the user-generated alert type with the official alert type assigned to each of the official alerts; determining, by the alert generation server based on the correlation, that the user-generated alert data corresponds to a particular alert event in the plurality of alert events; and updating the definition of the particular alert event to include the user alert geographic location code and the user-generated alert type.

In some embodiments, the method may include defining, by the mobile alert application operating on that mobile device, a user input interface on the mobile device that includes a plurality of pre-defined alert types; receiving, by the mobile alert application operating on that mobile device, a user input selecting one of the pre-defined alert types; and defining, by the mobile alert application operating on that mobile device, the user-generated alert type as the selected pre-defined alert type.

In some embodiments, the method may include receiving, by the mobile alert application operating on that mobile device, an alert generation input indicating the creation of the user-generated alert data; and automatically generating, by the mobile alert application operating on that mobile device, the alert location data in response to the alert generation input by identifying mobile device location data defining a current location of the mobile device.

In some embodiments, the method may include receiving, by the alert generation server, user-generated alert data from the mobile alert application operating on a plurality of additional mobile devices, the user-generated alert data from each additional mobile device including a corresponding user-generated alert type and corresponding alert location data; determining, by the alert generation server, that the user-generated alert data received from at least one of the additional mobile devices relates to the same alert event as the user-generated alert data received from the particular mobile device; determining, by the alert generation server, that the user-generated alert data received from the at least one of the additional mobile devices includes alert location data identifying a location external to the geographic region defined by the geographic region code of that alert event; and modifying the geographic region code of that alert event to include the location defined by the alert location data received from the at least one of the additional mobile devices.

In some embodiments, the method may include receiving, by the alert generation server, user-generated alert data from the mobile alert application operating on a specific mobile device, where the user-generated alert data includes user-generated alert media captured by the mobile device; associating, by the alert generation server, the user-generated alert media with the alert event related to that received user-generated alert data; and generating, by the mobile alert application operating on the mobile device, the alert notification to include a user-generated media prompt, the user-generated media prompt enabling a user of the at least one mobile device to initiate playback of the user-generated alert media associated with that alert event.

In some embodiments, the method may include generating, by the mobile alert application operating on the mobile device, the alert notification to include a user-generated data prompt, the user-generated data prompt enabling a user of the at least one mobile device to input user-generated alert data related to the one of the alert events.

In some embodiments, the method may include generating, by the mobile alert application operating on the mobile device, the alert notification to include a user feedback prompt, the user feedback prompt enabling a user of the at least one mobile device to input an alert score indicating an accuracy of the alert notification; transmitting the alert score to the alert generation server; and updating, by the alert generation server, the definition of the one of the alert events in response to receiving the alert score.

In some embodiments, the method may include, for each of at least one of the official alerts extracting, by the alert generation server, alert location information from the received official alert data by determining that the official alert data received from the official alert system corresponding to that official alert includes text data describing an associated alert location; and extracting the identified text data; and generating the official alert geographic location code by correlating the extracted text data with a corresponding geo-code.

Other aspects and features of the teachings disclosed herein will become apparent, to those ordinarily skilled in the art, upon review of the following description of the specific examples of the present disclosure.

### BRIEF DESCRIPTION OF THE DRAWINGS

The drawings included herewith are for illustrating various examples of systems and methods of the present disclosure and are not intended to limit the scope of what is taught in any way. In the drawings:

FIG. 1 is a block diagram of an alert generation system for a plurality of mobile devices;

FIG. 2 is a block diagram illustrating components of the alert generation system of FIG. 1;

FIG. 3 is a flowchart illustrating a method of generating a location-based alert;

FIG. 4 is a flowchart illustrating an example sub-process for determining an official alert location;

FIG. 5 is a flowchart illustrating a method of defining user-generated alert data;

FIG. 6 illustrates an example regional alert notification display;

FIG. 7 illustrates another example regional alert notification display;

FIG. 8 illustrates an example alert notification display;

FIG. 9 illustrates an example detailed alert event display;

FIG. 10 illustrates an example user-generated alert interface display; and

FIG. 11 illustrates another example user-generated alert interface display.

### DETAILED DESCRIPTION

Various systems or methods will be described below to provide an example of an embodiment of each claimed invention. No embodiment described below limits any claimed invention and any claimed invention may cover methods or systems that differ from those described below. The claimed subject matter is not limited to systems or methods having all of the features of any one system or method described below, or to features common to multiple or all of the systems or methods described below. It is possible that a system or method described below is not an embodiment that is recited in any claimed invention. Any subject matter disclosed in a system or method described below that is not claimed in this document may be the subject matter of another protective instrument, for example, a continuing patent application, and the applicant(s), inventor(s) and/or owner(s) do not intend to abandon, disclaim or dedicate to the public any such subject matter by its disclosure in this document.

The drawings, described herein, are provided for purposes of illustration, and not of limitation, of the aspects and features of various examples described herein. For simplicity and clarity of illustration, elements shown in the drawings have not necessarily been drawn to scale. The dimensions of some of the elements may be exaggerated relative to other elements for clarity. It will be appreciated that, for simplicity and clarity of illustration, where considered appropriate, reference numerals may be repeated among the drawings to indicate corresponding or analogous elements or steps.

In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It should also be noted that the terms “coupled” or “coupling” as used herein can have several different meanings depending in the context in which these terms are used. For example, the terms coupled or coupling may be used to indicate that an element or device can electrically, optically, or wirelessly send data to another element or device as well as receive data from another element or device.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

The examples of the systems and methods described herein may be implemented as a combination of hardware or software. In some cases, the examples described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g., a pushbutton keyboard, mouse, a touchscreen, and the like), and at least one output device (e.g., a display screen, a printer, a wireless radio, and the like) depending on the nature of the device.

It should also be noted that there may be some elements that are used to implement at least part of the examples described herein that may be implemented via software that is written in a high-level computer programming language such as object oriented programming. Accordingly, the program code may be written in C, C++ or any other suitable programming language and may comprise modules or classes, as is known to those skilled in object oriented programming. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the examples described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage.

The present disclosure relates generally to systems and methods for generating location-based alerts. The systems and methods described herein generally include an alert generation server that is in communication with a plurality of mobile devices. Each of the mobile devices may have a mobile alert application operating thereon.

The alert generation server can also communicate with a plurality of official alert systems. The official alert systems generally include systems that track a particular type of event. The alert generation server can communicate with the official alert systems to collect official alert data.

The official alert systems may be associated with various governmental and non-governmental organizations, such as health event monitoring systems implemented by the World Health Organization, and travel advisory monitoring systems implemented by government organizations. Examples of official alert systems can include weather monitoring systems, earthquake monitoring systems, volcano monitoring systems, flood monitoring systems, health/epidemic monitoring systems, government alert monitoring systems such as emergency event monitoring systems, public safety monitoring systems, amber alert monitoring systems and so forth.

The alert generation server can process the received alert data to generate alert events. The alert generation server may extract location-related data from the received alert data. The alert generation server may then analyze the location-related data to define geographic location codes for the received alert data. The geographic location codes can be identified for an alert event to define a geographic region associated with that alert event (i.e. where that alert event is occurring).

These alert events may then be shown to users through the mobile alert application. The mobile alert application may configure the mobile device to display alert event identifiers and alert event notifications via mobile alert user interfaces. The mobile alert application may also provide input interfaces that allow the mobile device to capture user-generated alert data.

The alert generation server can communicate with the mobile alert application operating on one or more mobile devices to collect user-generated alert data from those devices. This may allow users of the mobile alert application to identify additional alert events and/or provide additional or updated alert data associated with an existing alert event.

The mobile alert application may generate a plurality of graphical user interfaces to display alert event data to users. For example, the mobile alert application may provide map-based user interfaces that allow users to select various geographic locations shown on a map. The alert generation server may define geographic location codes for the various alert events that correspond to locations within the map-view defined by the mobile alert application. As a user navigates through the map-based user interfaces, alert event identifiers can be displayed based on the geographic location codes of the corresponding alert events.

For example, a user may be interested in reviewing alert events related to a region they are planning on visiting or may be planning to visit. The user may then navigate, using the map-based interface to that region in the map-view. The mobile alert application can identify alert events that correspond to the region displayed in the map interface using the geo codes assigned to the alert events by the alert generation server. Alert event identifiers for the relevant alert events may then be displayed by the mobile alert application.

In some cases, the mobile alert application may integrate with a calendar application operating on the user's mobile device. The mobile alert application may extract travel related data from the calendar application to identify potentially relevant geographic locations. The mobile alert application may then display to a user alert events associated with the geographic locations for upcoming events defined by the local calendar application.

The mobile alert application can also provide additional user interfaces to enable a user of the mobile device to define user-generated alert data. A user may input additional alert data, such as user-generated media or user feedback regarding an existing alert. The user may also define user-generated alert data related to new alert events not previously identified from the official alert data received by the alert generation server. The mobile alert application can transmit this user-generated alert data to the alert generation server. The alert generation server can then update the plurality of alert events using the user-generated alert data.

The mobile alert application can also generate alert notifications for the mobile device user. The alert notifications can identify for a user alert events occurring in the vicinity of the mobile device. These alert notifications can be output to a user through a user interface, or using other output components of the mobile device such as auditory or tactile feedback. This may alert the user to events occurring in their vicinity.

The alert generation server and/or mobile alert application may trigger alert event notifications for a mobile device by monitoring location data from the mobile device. For instance, when location data from a mobile device indicates that the mobile device is within a threshold proximity of the graphic region defined for an alert event, a notification can be triggered by the mobile alert application.

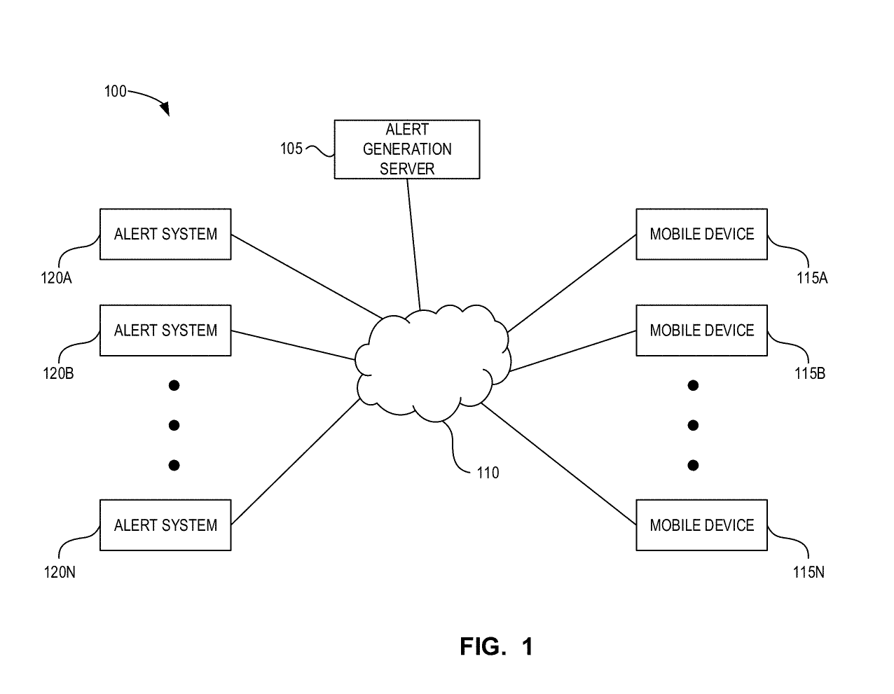

Referring now to FIG. 1, there is provided is a block diagram of an example of an alert generation computer network system 100. Alert generation computer network system 100 is configured to identify and monitor alert events and generate alert event notifications for a plurality of mobile devices 115A-115N.

Alert generation computer network system 100 generally comprises a plurality of computers connected via data communication network 110, which itself may be connected to the Internet. In general, however, the alert generation computer network system 100 includes an alert generation server 105, a plurality of official alert systems 120A-120N, and a plurality of mobile devices 115A-115N.

The alert generation server 105 can communicate with the official alert systems 120A-120N over network 110. The plurality of official alert systems 120A-120N can include a plurality of independent alert systems 120 that each monitors one or more types of alert events. For example, the alert systems 120 can include independent alert systems monitoring one or more of weather type events, earthquake event, volcano events, flood events, tropical storm events, health events, and government safety alerts (e.g., emergency, public safety, amber alerts).

The alert generation server 105 can also communicate with the plurality of mobile devices 115A-115N using the network 110. Each of the mobile devices 115 can have a mobile alert application operating thereon to facilitate communication with the alert generation server 105.

Typically, the connection between network 110 and the Internet may be made via a firewall server (not shown). In some cases, there may be multiple links or firewalls, or both, between network 110 and the Internet. Some organizations may operate multiple networks 110 or virtual networks 110, which can be internetworked or isolated. These have been omitted for ease of illustration, however it will be understood that the teachings herein can be applied to such systems. Network 110 may be constructed from one or more computer network technologies, such as IEEE 802.3 (Ethernet), IEEE 802.11 and similar technologies.

Computers and computing devices may be connected to network 110 or a portion thereof via suitable network interfaces. In some cases, one or more of the computing devices such as the mobile devices 115 may connect to network 110 via the Internet.

Examples of computer systems include the official alert systems 120, which generally include one or more computers such as a desktop or laptop computer, which can connect to network 110 via a wired Ethernet connection or a wireless connection. The official alert systems 120 may also connect to the network 110 via the Internet. The official alert systems 120 generally have a processor, volatile memory and non-volatile storage memory, at least one network interface, input devices such as a keyboard and trackpad, output devices such as a display and speakers, and various other input/output devices as will be appreciated.

Mobile devices 115 generally refer to a smartphone or tablet computer; however mobile devices 115 may also include a wide variety of “smart” devices capable of data communication. Mobile device 115 has a processor, volatile and non-volatile memory, at least one network interface, and input/output devices. Mobile device 115 is typically portable, and may at times be connected to network 110 or a portion thereof. In some cases, one or more of the mobile devices 115 may be replaced by a portable computer such as a laptop computer.

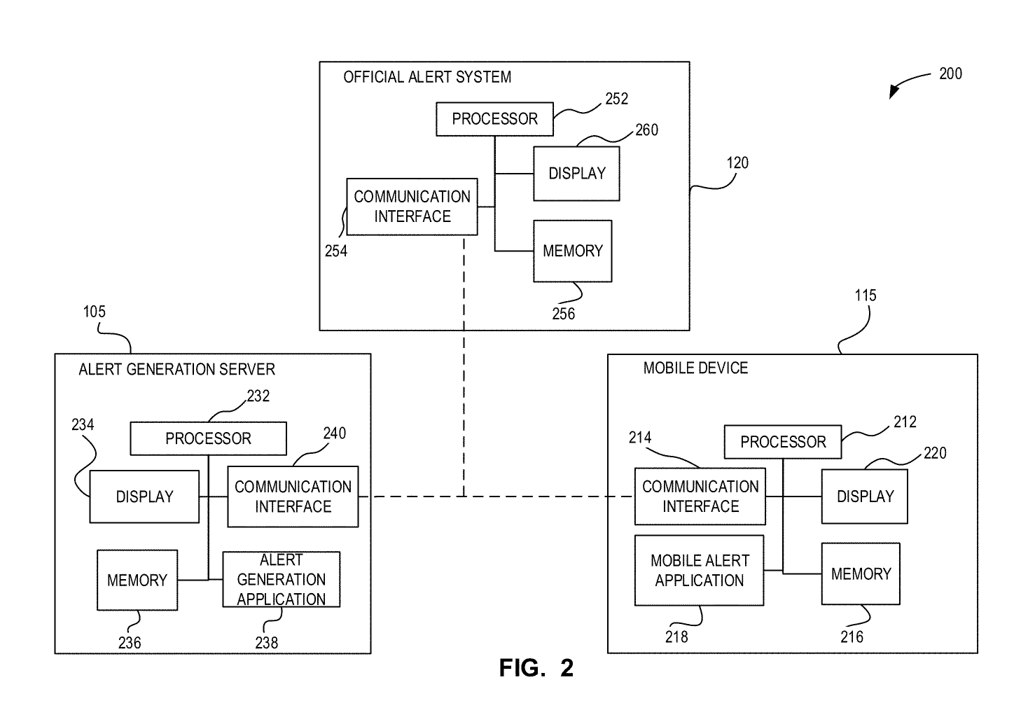

Alert generation server 105 is a computer or computer server, and has a processor, volatile and non-volatile memory, at least one network interface, and may have various other input/output devices. As shown, alert generation server 105 is linked to network 110. However, in other examples, alert generation server 105 may be outside network 110 and linked to the Internet. The alert generation server 105, official alert systems 120 and mobile devices 115 are described in greater detail with reference to FIG. 2 below. As with all devices shown in alert generation computer network system 100, there may be multiple alert generation servers 105, although not all are shown.

Alert generation server 105 may be configured to collect, analyze, and monitor official alert data from each of the official alert systems 120. For instance, alert generation server 105 may collect official alert data related to health alert events from a first official alert system 120A and official alert data related to earthquake alert events from a second official alert system 120B. The alert generation server 105 may also be configured to collect, analyze and monitor user-generated alert data from the mobile devices 115A-115N.

The alert generation server 105 can be configured to define alert events using the official alert data and user-generated alert data. The alert generation server 105 may also be configured to, in combination with a mobile alert application operating on one of the mobile devices 115, generate alert notifications for that mobile device 115. The alert notifications can indicate to a user of the mobile device 115 that an alert event is occurring in a nearby vicinity.

As used herein, the term “software application” or “application” refers to computer-executable instructions, particularly computer-executable instructions stored in a non-transitory medium, such as a non-volatile memory, and executed by a computer processor. The computer processor, when executing the instructions, may receive inputs and transmit outputs to any of a variety of input or output devices to which it is coupled.

A software application can be, for example, a monolithic software application, built in-house by the organization and possibly running on custom hardware; a set of interconnected modular subsystems running on similar or diverse hardware; a software-as-a-service application operated remotely by a third party; third party software running on outsourced infrastructure, etc. In some cases, a software application also may be less formal, or constructed in ad hoc fashion, such as a programmable spreadsheet document that has been modified to perform computations for the organization's needs. For example, for many organizations, important applications and services rely on regular input from spreadsheets that may be obtained from third parties, so these spreadsheets may be identified as software applications. Software applications can also include mobile device applications, such as applications built with react-native that may operate with mobile operating systems such as Android and iOS.

Referring now to FIG. 2, there is shown a block diagram of an example of an alert generation system 200. Alert generation system 200 is a simplified example of the alert generation system shown in FIG. 1 illustrating components of the alert generation server 105, an official alert system 120 and a mobile device 115.

Alert generation system 200 is constructed from alert generation server 105, an official alert system 120 and a mobile device 115. In some cases, an official alert system 120 and alert generation server 105 may be integrated or co-located.

Typically, the alert generation server 105 will be in communication with a plurality of mobile devices as shown in FIG. 1. Each of the mobile devices may be configured in a manner analogous to the mobile device 115 shown in system 200.

Similarly, the alert generation server 105 will typically be in communication with a plurality of official alert systems as shown in FIG. 1. Each of the official alert systems may be configured in a manner analogous to the official alert system 120 shown in system 200.

Alert generation server 105 may be directly linked to official alert system 120, for example, via a Universal Serial Bus, Bluetooth™ or Ethernet connection. Alternatively, alert generation server 105 may be linked to official alert system 120 via network 110 or, in some cases, the Internet. Alert generation server 105 may also be linked to mobile device 115 via network 110 or, in some cases, the Internet.

Alert generation server 105 has a processor 232, a display 234, a memory 236, a communication interface 240 and an alert generation application 238. Although shown as separate elements, it will be understood that alert generation application 238 may be stored in memory 236.

Processor 232 is a computer processor, such as a general purpose microprocessor. In some other cases, processor 232 may be a field programmable gate array, application specific integrated circuit, microcontroller, or other suitable computer processor.

Processor 232 is also coupled to display 234, which is a suitable display for outputting information and data as needed by various computer programs. In particular, display 234 may display a graphical user interface (GUI). In some cases, the display 234 may be omitted from alert generation server 105, for instance where the alert generation server 105 is configured to operate autonomously. In such cases, the alert generation server 105 may be configurable using a remote computer that is connected to the alert generation server 105. Alert generation server 105 may execute an operating system, such as Microsoft Windows™, GNU/Linux, or other suitable operating system.

Communication interface 240 is one or more data network interface, such as an IEEE 802.3 or IEEE 802.11 interface, for communication over a network.

Processor 232 is coupled, via a computer data bus, to memory 236. Memory 236 may include both volatile and non-volatile memory. Non-volatile memory stores computer programs consisting of computer-executable instructions, which may be loaded into volatile memory for execution by processor 232 as needed. It will be understood by those of skill in the art that references herein to alert generation server 105 as carrying out a function or acting in a particular way imply that processor 232 is executing instructions (e.g., a software program such as alert generation application 238) stored in memory 236 and possibly transmitting or receiving inputs and outputs via one or more interface. Memory 236 may also store data input to, or output from, processor 232 in the course of executing the computer-executable instructions.

The memory 236 on alert generation server 105 may store a software application referred to herein as an alert generation application 238. The alert generation application 238 may be configured to collect alert data (including official alert data and user-generated alert data), identify and define alert events, and generate alert notifications for mobile devices 115.

The memory 236 may also store a database. In some examples, the database may be a relational database. In other examples, the database may be a non-relational database, such as a key-value database, NoSQL database, or the like. The database may be used to store alert data, such as official alert data received from official alert system 120 and/or user-generated alert data received from mobile device 115. The alert generation server 105 can access the database to monitor and analyze the stored alert data. The database may also be used to store processed alert data generated by the alert generation server 105 using the official alert data and/or user-generated alert data.

The database may also store additional configuration or analysis related data for user by the alert generation application 238. For example, the official alert data received from different official alert systems 120 may be defined using different alert data formats. The database may store an official alert data format for the official alert systems 120 that can be used to identify relevant portions of the official alert data received from those official alert systems.

The database may also store mappings between different location definitions and the geo-codes used by the alert generation server 105 to define alert events. These mappings may be used by the alert generation server 105 to identify the geo-codes to be assigned to alert events based on the received official alert data.

The database may also store various types of user-generated data received from mobile device 115. For example, the database may store user-generated alert media and/or user-generated alert feedback related to alert events. The alert generation server 105 may access the stored user-generated data to update the previously defined alert events and/or define additional alert events.

The database may also store various characteristics associated with the alert events defined by the alert generation server 105. For example, the alert generation server 105 may define an alert validity period for an alert event. The alert validity period may define the period of time for which that alert event remains current (i.e. is ongoing) and should be displayed to mobile device users. The alert generation server 105 can use the defined alert validity period to determine when alert events should be deleted or purged to ensure that users are provided with real-time data.

In some cases, the official alert data received from an official alert system 120 can include a recommended alert expiry. The alert generation server 105 may then define an initial alert validity period based on the recommended alert expiry. In other cases, the alert generation server 105 may define the initial alert validity period based on other characteristics of an alert event, such as an alert type. For instance, the database may store default alert validity periods for the various alert types.

In some cases, the alert validity period for an alert event may be substantially fixed. Alternatively, the alert validity period may be variable over time. For example, the alert generation server 105 may monitor user activity related to a particular alert event, such as user-generated alert data, user feedback, and/or user-generated alert media. The alert generation server 105 may extend the alert validity period if ongoing user activity is detected.

Mobile devices 115 generally refer to a smartphone or tablet computer; however mobile devices 115 may also include a wide variety of “smart” devices capable of data communication. Mobile device 115 is typically portable, and may at times be connected to network 110 or a portion thereof.

Mobile device 115 has a processor 212, a communication interface 214 for data communication with communication interfaces 240 and 254, a display 220 for displaying a various GUIs, such as alert notification and user alert generation GUIs for example, and a memory 216 that may include both volatile and non-volatile elements. The mobile device 115 can also include various input devices, such as keyboards, touchscreens, microphones, cameras, etc., as well as various other output devices such as audio speakers, and tactile feedback components. The mobile device 115 can also include various location monitoring systems or services, such as GPS components.

As with alert generation server 105, references to acts or functions by mobile device 115 imply that processor 212 is executing computer-executable instructions (e.g., a software program) stored in memory 216. For instance, a mobile alert application 218 may be stored on the mobile device 115. Although shown separately from memory 216, it will be understood that mobile alert application 218 may be stored in memory 216. The mobile alert application 218 may communicate with the alert generation application 238 of alert generation server 105 to assist the alert generation server 105 in collecting user-generated alert data and generating alert notifications. Although the mobile alert application 218 is shown as installed on mobile device 115, the mobile alert application 218 may be otherwise accessible to the mobile device 115 for instance as a cloud application accessible to the mobile device 115 over a network such as the Internet.

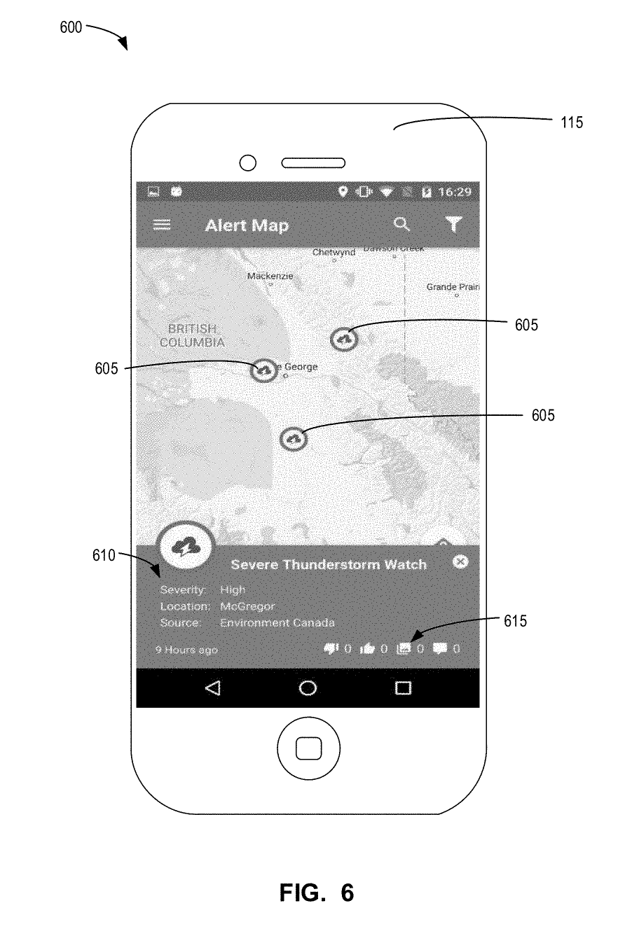

The alert generation application 238 of alert generation server 105 may remotely monitor user-generated alert data and/or location data stored on the mobile device 115, e.g., using the mobile alert application 218. The mobile alert application 218 may continually transmit the user-generated alert data to the alert generation server 105, e.g., as new user-generated data is input. In some cases, mobile alert application 218 may also transmit mobile device location data to the alert generation server 105, e.g., as changes are detected or on an intermittent basis. The mobile alert application 218 may also display notifications generated by alert generation server 105, e.g., indicate an alert event occurring within a nearby vicinity of the mobile device 115. Examples of graphical user interfaces that may be displayed by mobile alert application 218 using display 220 are discussed below with reference to FIGS. 6 to 11.

In general, the mobile alert application 218 may configure the mobile device 115 to display graphical user interfaces that provide users with a location-based alert notification system. The mobile alert application 218 can generate map-based graphical user interfaces that display alert events identified from both official alert systems and user-generated alert data. The mobile alert application 218 uses the geographical location codes defined by the alert generation server 105 to provide the user with fast access to appropriate alert identifiers and notifications based on a location of the mobile device 115 and/or a location identified in the map interface by a user of the mobile device 115.

In some cases, the mobile alert application 218 may determine location-based alert groups or clusters. The alert groups/clusters may be defined by the alert generation server 105 based on the geographical location codes associated with ongoing (i.e. not expired) alert events. The alert generation server 105 may then transmit alert cluster identification data to the mobile alert application 218 to allow the mobile alert application 218 to group ongoing alert events appropriately in the user interface provided to a user of mobile device 115. By grouping/clustering the alert events based on the associated geographical location codes, and filtering alert events based on the selected alert types, the mobile alert application 218 may rapidly identify the alert events to be displayed on the mobile device 115.

The location-based alert clusters may be defined based on a level of geographical granularity being display by the mobile alert application 218. For instance, where a larger geographic region is being shown, the clusters may be defined to include alert events over a larger sub-region of the user interface. The mobile alert application 218 may adjust and redefine the clusters shown on display 220 as a user adjusts the size of the region being shown.

The mobile alert application 218 can also provide alert notifications to identify alert events in the vicinity of the mobile device 115. The alert notifications may provide an indication to the user of the alert event occurring nearby. The mobile alert application 218 may also provide a user interface with additional alert data related to the alert event. In some cases, the mobile alert application 218 may display user-generated media, such as images or video, and/or user input such as comments, related to the alert event. The mobile alert application 218 may also provide interfaces to enable a user of the mobile device 115 to provide further user-generated alert data and/or alert media in response to the alert notification.

In some cases, the alert notifications may be displayed to a user as a pop-up within the mobile alert application 218. Additionally or alternatively, the alert notifications can include auditory, visual or tactile outputs via mobile device 115 to indicate to the user of mobile device 115 that an alert event is occurring nearby.

In some cases a user may adjust the settings of the mobile alert application 218 to define the manner in which the notification is displayed. For instance, a user may select particular alert types that the user is interested in to provide additional notification outputs, e.g., an auditory output or vibration.

Official alert system 120 is generally a computer similar to alert generation server 105. The official alert system 120 has a processor 252, a communication interface 254 for data communication with communication interfaces 214 and 240, a display 260, and a memory 256 that may include both volatile and non-volatile elements. As with alert generation server 105, references to acts or functions by official alert system 120 imply that processor 252 is executing computer-executable instructions (e.g., a software program) stored in memory 256.

The alert generation server 105, mobile device 115 and official alert system 120 may have various additional components not shown in FIG. 2. For example, additional input or output devices (e.g., keyboard, pointing device, etc.) may be included beyond those shown in FIG. 2.

The mobile alert application 218 may be a downloadable application, such as a mobile application, provided by the alert generation server 105. A user of the mobile device 115 may download the mobile alert application 218 from alert generation server 105 or through an app store such as the Apple App Store or Google Play. In other cases, the mobile alert application 218 may be a web-based application accessed by a user of the mobile device 115, over a network such as network 110 or the Internet.

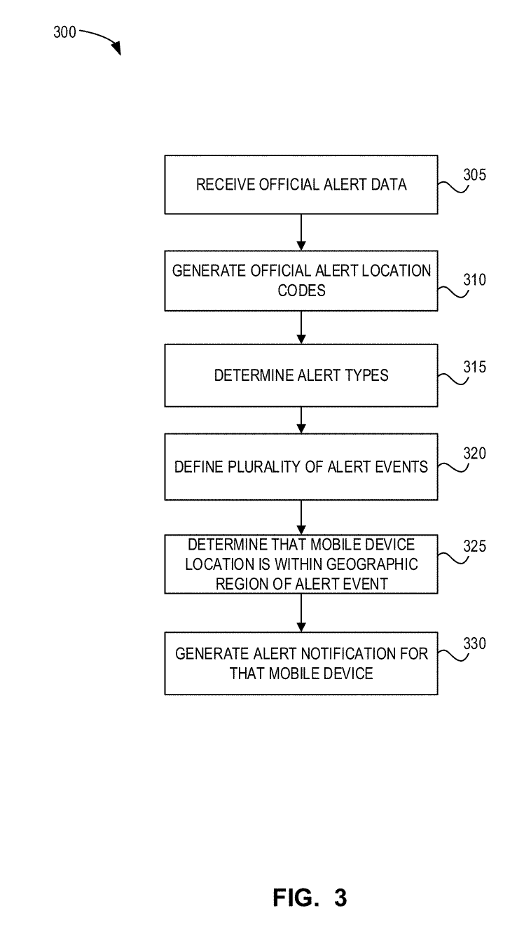

Referring now to FIG. 3, shown therein is a flowchart illustrating an example of a method or process 300 of generating a location-based alert for a mobile device user. Method 300 may be carried out by various components of system 200, such as the alert generation server 105 and the mobile device 115.

At 305, the alert generation server 105 can receive official alert data. The official alert data can be received from a plurality of official alert systems, such as official alert system 120. The official alert data can include alert data defining a plurality of official alerts.

In some cases, an official alert system 120 may broadcast an official alert message that includes official alert data related to an official alert. For example, an official alert system 120 that monitors health-related alerts may broadcast an official alert message when a disease epidemic (e.g., bird flu) has been identified for a particular region. The alert generation server 105 may access the broadcast official alert message and retrieve the official alert data from that message.

In some cases, the alert generation server 105 may periodically query one or more of the official alerts systems 120 for official alert data. For example, the alert generation server 105 may transmit an official alert query to an official alert system 120 (e.g., on a periodic basis) requesting any official alert data related to ongoing official alerts. The alert generation server 105 may then receive an official alert response that includes the official alert data.

The alert generation server 105 may communicate with the official alert systems 120 in various ways. For example, some official alert systems may have APIs (e.g., HTTP rest) or rss feeds that provide official alert data for each ongoing official alert monitored by that alert system. The alert generation server 105 may then retrieve the official alert data through the API or rss feed e.g., using a rapid polling frequency. In some cases, the alert generation server 105 may establish a persistent connection with an official alert system 120 (e.g., a socket or web socket) and retrieve the official alert data through the persistent connection. In some cases, the official alert system 120 may provide a push alert of any new official alert data when it becomes available.

At 310, the alert generation server 105 can generate an official alert location code for each of the official alerts in the plurality of official alerts. The official alert location code may define geographical latitude and longitude coordinates associated with the corresponding official alert. The alert generation server can also associate with the official alert location code with corresponding map tiles for multiple map zoom levels in a hierarchical quad key tile pattern.

In some cases, the alert generation server 105 may extract, for each official alert, corresponding alert location information from the received official alert data. The extracted alert location information may then be used by the alert generation server 105 to generate an official alert geographic location code for each official alert.

For example, the official alert data received from the official alert system 120 related to a particular official alert may include a geographic location code. The alert generation server 105 may then use this received geographic location code to define the official alert geographic location code for the particular official alert.

In some cases, the geographic location code received from one or more official alert systems 120 may differ slightly from the geographic location codes defined by the alert generation server 105. The alert generation server 105 may then normalize the received geographic location codes to provide consistent geographic location codes for official alerts received from distinct official alert systems 120.

For example, the alert generation server 105 may define a location code mapping for one or more official alert systems 120. The location code mapping may allow the alert generation server 105 to convert the geographic location codes received from the official alert system to normalized geographic location codes used by the alert generation server 105. The alert generation server 105 may store the location code mappings in a database on memory 236.

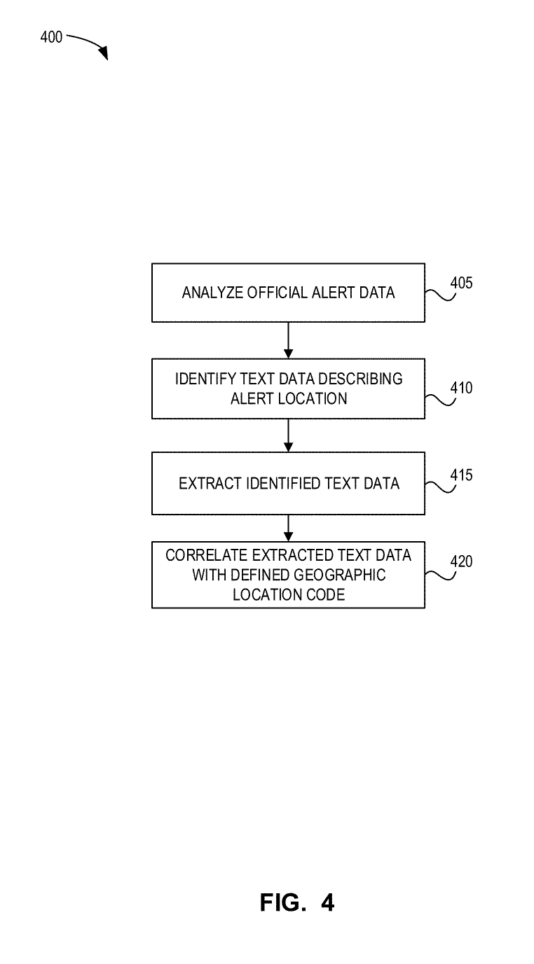

In some cases, the official alert data received from official alert system 120 may not include a geographic location code data. Rather, the official alert data may include a textual description of a location associated with the official alert. Accordingly, the alert generation server 105 can be configured to convert the textual description received from the official alert system 120 into a geographic location code. This may ensure that consistent geographic location codes are defined for the official alerts received from various different official alert systems 120 (and for user-generated alerts). An example process for converting a textual location description into a geographic location code is described in further detail below with reference to FIG. 4.

In some cases the alert generation server 105 may store an official alert data format for one of the official alert systems 120 in a database on memory 236. For instance, the alert generation server 105 may determine that the official alert data from a particular official alert system 120 is provided in a consistent format for each official alert. The alert generation server 105 may then identify various portions of the official alert data from that particular official alert system 120 based on this consistent format.

The official alert data format stored by alert generation server 105 may identify a geographic location portion of the official alert data. The alert generation server 105 may then use the stored alert data format, and the geographic location portion, to identify the portion of the received official alert data that identifies a corresponding geographic location. As a simplified example, the alert generation server 105 may determine that the official alert system generates official alert data in the format “[alert type] Warning for [geographic location]”. The alert generation server 105 may then identify the geographic location portion as the portion of the official alert data immediately following the terms “Warning for”.

The alert generation server 105 may also monitor changes in an alert location on an ongoing basis. For example, some of the official alerts may correspond to events that may change location over time (e.g., hurricane events). The alert generation server 105 may monitor the official alert data for those official alerts to identify changes in the associated alert location. The alert generation server may then update the assigned official alert location code based on the changes in the associated alert location. The alert generation server 105 may also monitor associated user-generated alert data to identify changes in the alert location as described below.

At 315, the alert generation server 105 can assign each of the official alerts an official alert type. The alert type may define a type or category of alert event indicated by that official alert. Examples of alert types may include, among others, a weather type alert (and perhaps sub-categories thereof), earthquake type alert, volcano type alert, flood type alert, tropical storm type alert, health type alert, and government safety type alert (which may include emergency type alert, public safety type alert, amber alerts).

The alert generation server 105 can define a plurality of potential alert types. These potential alert types can be stored in a database on memory 236. The alert generation server 105 may then assign one of those potential alert types to each official alert as the corresponding official alert type.

The alert generation server 105 may determine the official alert type for an official alert using the received official alert data. For example, an official alert system 120 may identify an associated alert type in the corresponding official alert data. The alert generation server 105 may then use this associated alert type to determine the official alert type to be assigned.

The alert generation server 105 may identify a textual alert type description in the received official alert data. The alert generation server 105 may then parse the textual alert type description to determine the alert type assigned by the official alert system.

As mentioned, in some cases the alert generation server 105 may store an official alert data format for one of the official alert systems 120 in a database on memory 236. The official alert data format may identify an alert type portion of the official alert data. The alert generation server 105 may then use the stored alert data format, and the alert type portion, to identify the portion of the received official alert data that identifies a corresponding alert type. Continuing with the simplified example described above, the alert generation server 105 may determine that the alert type portion of the official alert data is the portion immediately preceding the terms “Warning for”.

The alert generation server 105 may also generate an alert type mapping for each of the official alert systems. For example, an official alert system may use different grouping or terminology to define an alert type in the official alert data. The alert generation server 105 may then convert the alert types in the received official alert data to one of the stored potential alert types using the alert type mapping.

In some cases, the alert generation server 105 may determine the alert type by identifying the corresponding official alert system providing the official alert data. For example, the alert generation server 105 may determine that the corresponding official alert system only provides official alert data related to one alert type (e.g., an earthquake monitoring system that provides only earthquake type alerts). The alert generation server 105 may then store an assigned alert type for that official alert system in a database on memory 236. The alert generation server 105 may then determine the official alert system from which the official alert data was received, and assign the corresponding assigned alert type for the official alert.

In some cases, an official alert system 120 may monitor official alerts related to multiple types of alerts. In such cases, the alert generation server 105 may disaggregate the official alert data received from that official alert system 120 into official alert data corresponding to different, individual official alerts. The alert generation server 105 may then analyze the official alert data associated with each individual official alert, e.g., to determine the official alert location code and/or associated alert type.

In some cases, the alert generation server 105 may also determine an alert event severity based on the official alert data. The alert event severity may be determined by analyzing the received official alert data in manner analogous to determining the alert type. In some cases, the alert generation server 105 may normalize or correlate the alert severity data determined from the official alert data to provide a consistent alert severity measure for alert events from different official alert systems 120. The alert generation server 105 may also modify or update the alert severity defined by the official alert systems 120, e.g., based on user-generated alert data for that alert event indicating a different alert severity.

At 320, the alert generation server 105 can define a plurality of alert events based on the plurality of official alerts. The alert generation server 105 may define the plurality of alert events using the geographic location codes determined at 310 and the alert types assigned at 315.

In general, the alert generation server 105 can define each alert event to include a one or more event types. Each event type defined for an alert event can correspond to the official alert type determined at 315 for one of the official alerts. The alert generation server 105 can also define a geographic region for each alert event. The geographic region can be determined to correspond to the regions identified in corresponding official alert data.

In some cases, the alert generation server 105 may define an alert event that corresponds directly to one of the official alerts identified in the official alert data received at 305. In such cases, the alert event can be defined with an event type corresponding to the alert type assigned at 315 to that official alert. The alert event can also be defined to have a geographic region code that defines a geographic region that includes the location identified by the official alert geographic location code determined for that official alert at 310.

In some cases, the alert generation server 105 may determine that two or more of the official alerts correspond to the same alert event. The alert generation server 105 may then define the alert event using the alert types assigned to each of the corresponding official alerts at 315 and the official alert geographic location code defined for both official alerts at 310.

The alert generation server 105 may determine that two or more official alerts correspond to the same alert events based on the geographic location codes associated with those official alerts. For example, the alert generation server 105 may correlate the official alerts by comparing the geographic location codes determined at 310. The alert generation server 105 may determine that the geographic location codes are within a threshold event proximity (e.g., a pre-defined distance threshold such as 1 km or 10 km). The alert generation server 105 may then identify the official alerts as potentially related alerts.

In some cases, the alert generation server 105 may define the threshold event proximity as a fixed threshold proximity such as 1 km or 10 km for example. In other cases, the alert generation server 105 may define the threshold event proximity as a variable threshold proximity, e.g., that varies proportionally based on the size of the geographic region associated with the official alert geographic location codes determined at 310.

In some case, the alert generation server 105 may determine that potentially related official alerts corresponds to the same alert event based on the official alert types assigned thereto. The alert generation server 105 may identify a plurality of sets of potentially related alert types. Each set of potentially related alert types may be defined based on two or more types of alert events likely to occur in conjunction with one another, or having a potentially causal relationship. For example, certain weather alert types (e.g., extreme precipitation alert types and/or tropical storm alert types) may be considered potentially related to flood alert types. The alert generation server 105 may then determine that the potentially related official alerts correspond to the same alert event where the corresponding alert types are potentially related alert types.

In some cases, the alert generation server 105 may determine that the alert types of the potentially related official alerts are unlikely to be correlated. The alert generation server 105 may then define separate alert events for those unrelated official alerts that may nonetheless have overlapping or partially overlapping geographic regions. For example, where the alert type of a first official alert was determined to be an amber alert type and the alert type of a second official alert was determined to be an earthquake event, the alert generation server 105 can define separate alert events for those official alerts.

In some cases, the alert generation server 105 may define the plurality of alert events using user-generated alert data. The user-generated alert data can be combined with, or used separately from, the official alert data to define the plurality of alert events.

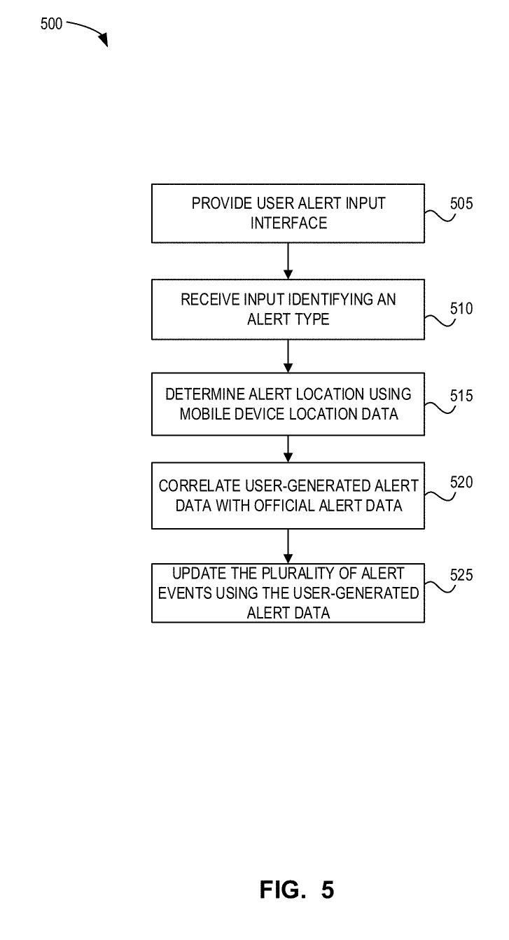

The alert generation server 105 may receive user-generated alert data from the mobile alert application 218 operating on a particular mobile device 115 in the plurality of mobile devices 115A-115N. The user-generated alert data can include a user-generated alert type and alert location data. The alert generation server 105 may then use this received user-generated alert data to define the plurality of alert events. An example process for collecting user-generated alert data, and defining alert events using user-generated alert data, is described in further detail below with reference to FIG. 5.

At 325, the mobile alert application 218 operating on mobile device 115 can determine that the mobile device is located within a threshold notification proximity of the geographic region associated with one of the alert events defined at 320. In some cases, the threshold notification proximity may be a fixed proximity threshold, e.g., 1 km from an ongoing alert event or even the geographic region of the alert event. In other cases, the threshold notification proximity may be variable based on the size of the geographic region associated with the ongoing alert event, e.g., a distance from the edge of the geographic region that is proportional to the size of the geographic region.

In some case, a user of the mobile device 115 may modify the threshold notification proximity for the mobile alert application 218 operating on their mobile device 115. For example, a user may select a defined threshold notification proximity for the mobile alert application 218 to use when determining whether to initiate and alert notification for that user. This may allow a user to adjust the alert notifications they are likely to receive depending on their personal preferences.

The mobile alert application 218 operating on a mobile device 115 can monitor location data generated by that mobile device 115 on an ongoing basis, e.g., continually or in response to changes in the location data. The mobile alert application 218 may determine that the mobile device is within the threshold notification proximity by comparing the location data to the geographic location codes of the alert events defined by the alert generation server 105.

In some cases, the mobile alert application 218 may receive alert event data from the alert generation server 105 on an ongoing basis. For example, the alert generation server 105 may transmit alert event data to the mobile device 115 on an ongoing basis (e.g., continually or at periodic intervals), in response to changes in event data or the generation of new alert events, and/or in response to requests from the mobile alert application 218 operating on mobile device 115. The mobile alert application 218 may then determine that the mobile device is within the threshold proximity of the alert event locally on the mobile device, using the geographic location codes included in the alert event data receives from the alert generation server 105.

In some cases, the mobile alert application 218 may transmit the location data from the mobile device 115 to the alert generation server 105. The mobile alert application 218 may transmit the location data on an ongoing basis (e.g., continually or at periodic intervals), in response to changes in the location data, and/or in response to requests from the alert generation server 105.

In some cases, the alert generation server 105 may then determine whether the location data received from the mobile device 115 corresponds to the threshold notification proximity of an ongoing alert event. The alert generation server 105 may then transmit a notification response to the mobile alert application 218 indicating that the mobile device is within the threshold notification proximity of the geographic region of the alert event.

At 330, the mobile alert application 218 operating on the mobile device 115 can generate an alert notification for that mobile device 115. The alert notification generated at 330 can identify the alert event that is occurring. The alert notification can also indicate that the mobile device is within a threshold notification proximity of the geographic region of the alert event. The alert notification may be displayed to a user of mobile device 115, through a GUI shown on display 220 such as the GUIs shown in FIGS. 6 to 9 and described herein.

In some cases, alert notification data may be included in a notification response sent by the alert generation server 105 to the mobile device 115. The mobile alert application 218 can then generate the alert notification using the received alert notification data.

Referring now to FIG. 4, shown therein is a flowchart illustrating an example of a method or process 400 of determining an official alert location. Method 400 may be carried out by various components of system 200, such as the alert generation server 105 and the mobile device 115.

At 405, the alert generation server 105 can analyze the received official alert data to determine if location data is defined for each official alert. The alert generation server 105 may analyze the received official alert data to determine if a geo-location code is associated with any of the official alerts. If a geo-location code is associated with an official alert, the alert generation server 105 can then determine the official alert geographic location code for that official alert using the associated geo-location code.

In some cases, the alert generation server 105 may determine that the official alert data does not include a geo-location code. In such cases, the alert generation server 105 may further determine whether the official alert data includes any data identifying the geographic location of the associated official alert.

At 410, the alert generation server 105 can determine that the official alert data for one of the official alerts includes text data describing an associated alert location. In some cases, the alert generation server 105 may identify the text data by processing the official alert data to identify text corresponding to known location identifiers (e.g., counties, cities, towns, postal or zip codes, etc.).

As mentioned, in some cases the alert generation server 105 may store an official alert data format for one or more of the official alert systems 120 in a database on memory 236. The official alert data format stored by alert generation server 105 may identify a geographic location portion of the official alert data. The alert generation server 105 may then use the stored alert data format, and the geographic location portion, to identify the portion of the received official alert data that identifies a corresponding geographic location.

At 415, the alert generation server 105 can extract the text data identified at 410. The alert generation server 105 may extract or isolate that portion of the text data identified at 410 for further processing in order to identify the geographic location associated with the official alert.

At 420, the alert generation server 105 can correlate the text data extracted at 115 with a plurality of pre-defined geographic location codes. For example, the alert generation server 105 may store a plurality of geographic code associations in a database on memory 236. The geographic code associations may identify the geographic code associated with a particular text description of a location.

For instance, the alert generation server 105 may access a geocoding library stored on the database or external to the alert generation server. An example of such a geocoding library may be the node.js library open geocoder. The alert generation server 105 may then provide the extracted text data from 115 as an input to the geocoding library. The alert generation server 105 may then define the geographic location code based on the corresponding output from the geocoding library.

The alert generation server 105 can use the geographic code associations to convert the text data received as part of the official alert data into official alert geographic location codes. The official alert location code may be defined as geographical latitude and longitude coordinates associated with the corresponding official alert. The alert generation server can also associate with the official alert location code with corresponding map tiles for multiple map zoom levels in a hierarchical quad key tile pattern.

Referring now to FIG. 5, shown therein is a flowchart illustrating an example of a method or process 500 of defining user-generated alert data. Method 500 may be carried out by various components of system 200, such as the alert generation server 105 and the mobile devices 115.

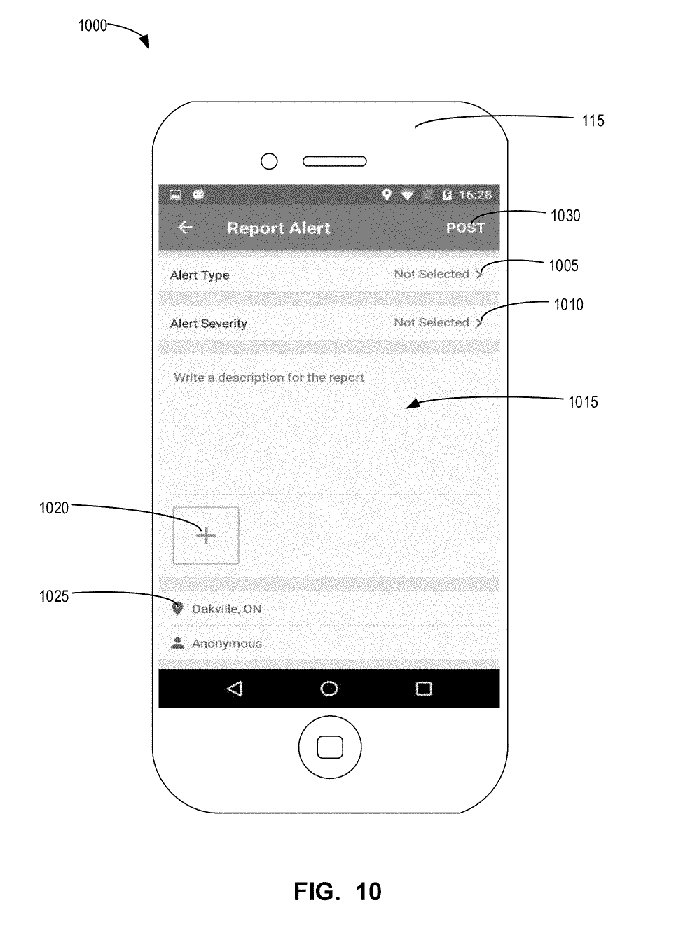

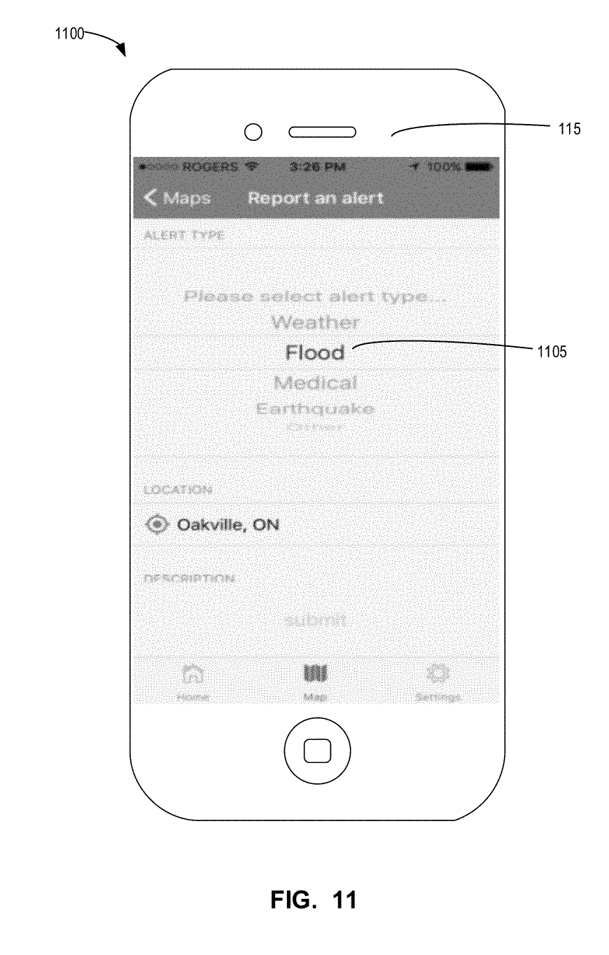

At 505, the mobile alert application 218 operating on the mobile device 115 can provide a user alert input interface. The user alert input interface may enable a user of the mobile device 115 to provide user-generated alert data. This user-generated alert data may be used by the alert generation server 105 to define, or update, the plurality of alert events. Examples of user alert input interfaces are shown in FIGS. 10 and 11 described herein.

At 510, the mobile alert application 218 operating on the mobile device 115 can receive a user input identifying an alert type. A user can provide input to the mobile alert application 218 through the interface provided at 505.

A user of mobile device 115 may provide input in various forms. For example, the mobile alert application 218 may configure the mobile device 115 to receive voice inputs defining a user-generated alert event. A user of mobile device 115 may issue verbal commands that are received via the microphone on mobile device 115. The mobile alert application 218 may then identify the alert type from the received voice commands.

In some cases, the user input interface defined at 505 may include a plurality of pre-defined alert types. For example, as shown in FIG. 11 described herein a plurality of pre-defined alert types may be displayed to the user on display 220. A user may then identify the appropriate alert type from the user input interface.

The input received at 510 may include a selection of one of those pre-defined alert types. For example, a user may select one of the pre-defined alert types using a touchscreen of the mobile device 115. Alternatively, a user may identify one of the pre-defined alert types verbally. The mobile alert application 218 can then determine the user-generated alert type for the user-generated alert as the selected pre-defined alert.

At 515, the alert generation server 105 can determine a user-generated alert location using mobile device location data received from the mobile alert application 218. The mobile alert application 218 can transmit the user-generated alert location to the alert generation server 105 along with the other user-generated alert data. The alert generation server 105 may then define a user-alert geographic location code for the user-generated alert data based on the alert location data.

In some cases, the mobile device 115 can be configured by the mobile alert application 218 operating thereon to automatically generate the alert location data. The mobile alert application 218 may receive an alert generation input indicating the creation of the user-generated alert data (e.g., a user selecting a “report alert” interface, or issuing appropriate verbal commands). The mobile alert application 218 may then automatically generate the alert location data in response to the alert generation input by identifying mobile device location data defining a current location of the mobile device 115.

In some cases, the mobile device location data can be determined based on cellular location data. Additionally or alternatively, the mobile device location data can be generated using other location services operating on the mobile device 115, such as GPS data. In some cases, the mobile device location data may be determined using other devices with which the mobile device 115 is currently communicated, such as a Wi-Fi network the mobile device 115 is connected to.

At 520, the alert generation server 105 can correlate the user-generated alert data with official alert data. The alert generation server 105 may correlate the user-generated alert data and official alert data in a manner analogous to that described above at 320 for determining whether two official alerts relate to the same alert event.

The alert generation server 105 can compare the user alert geographic location code with the official alert geographic location codes generated for each of the official alerts. The alert generation server 105 may then determine that the user-generated alert is potentially related to one or more of the official alerts by determining if the user alert geographic location code is within a threshold event proximity of the official events.

The alert generation server 105 can also compare the user-generated alert type with the official alert type assigned to each of the official alerts. The alert generation server 105 may determine that potentially related official events correspond to the user-generated alert if the compared alert types are included in a set of potentially related alert types.

Based on the comparison of the user-alert geographic location codes and official alert geographic location codes, and the user-generated alert types and official alert types, the alert generation server 105 can determine whether the user-generated alert data corresponds to a new alert event or to an existing alert event.

At 525, the alert generation server 105 can update the plurality of alert events using the user-generated alert data. In general, updating the plurality of alert events can include updating associated alert event data such that the alert type defined by the alert generation server 105 for one of the alert events corresponds to the user-generated alert type and the geographic code defined by the alert generation server 105 for the one of the alert events defines a geographic region including the location indicated by the user-alert geographic location code.

In some cases, it may not be necessary to update the plurality of alert events in response to each received user-generated alert. For example, where the alert generation server 105 determines, based on the correlations at 520, that the user-generated alert corresponds to an existing alert event, that alert event may not need to be updated if the user-generated alert data is already reflecting in the alert event data previously defined by the alert generation server 105.

As mentioned, the alert generation server 105 may determine at 520 that the user-generated alert corresponds to an additional alert event. The alert generation server 105 may then update the plurality of alert events to include an additional alert event using the user-generated alert type and user alert geographic location code for the user-generated alert. The alert generation server 105 can define the additional alert event to include a defined event alert type that corresponds to the user-generated alert type and a geographic region code that defines a geographic region for the additional alert event that includes the location identified by the user alert geographic location code.

In some cases, the alert generation server 105 may determine at 520 that the user-generated alert data corresponds to a particular alert event in the plurality of alert events. The alert generation server 105 can then update the definition of the particular alert event to include the user alert geographic location code and the user-generated alert type. For example, the user alert geographic location code may correspond to a geographic region nearby, but outside, the region currently associated with the alert event. The geographic region code for the alert event may then be updated to include this additional region. In some cases, the geographic region code may be further updated by the alert generation server 105 to exclude previously include areas, e.g., in response to user-generated alert data indicating that the alert event has shifted or was previously associated with an inaccurate geographic region.

The alert generation server 105 may receive user-generated alert data from the mobile alert applications 218 operating on a plurality of mobile devices 115. The user-generated alert data received from each mobile device 115 can include a corresponding user-generated alert type and corresponding alert location data. The alert generation server 105 may then correlate the received user-generated alert data with user-generated alert data from the other mobile devices 115, and the official alert data as described above.

In some cases, the alert generation server 105 can determine that the user-generated alert data received from at least one additional mobile device 115 relates to the same alert event as the user-generated alert data received previously another mobile device 115. The alert generation server 105 may then update the user-generated alert event to reflect the user-generated alert data received from each user.

For example, the alert generation server 105 may determine that the user-generated alert data received from the additional mobile device 115 includes alert location data identifying a location external to the geographic region defined by the geographic region code of the existing alert event. The alert generation server 105 can then modify the geographic region code of that alert event to include the location defined by the alert location data received from the additional mobile device.

In some cases, the mobile alert application 218 can enable a user of mobile device 115 to include user-generated alert media with the user-generated alert data. The user-generated alert media can include media data captured by the mobile device 115, e.g., using a camera and/or microphone. The alert generation server 105 can then associate the user-generated alert media with the alert event related to that received user-generated alert data.

To facilitate the generation of user-generated alert media, the mobile alert application 218 can provide an input interface that enables a user of the mobile device 115 to generate alert media. An example of such an interface is shown in FIG. 10 described herein.

In some cases, the mobile alert application 218 can generate the alert notification to include a user-generated media prompt. The user-generated media prompt may enable a user of the at least one mobile device to display or initiate playback of the user-generated alert media associated with that alert event. A user may interact with the user-generated media prompt to access the user-generated alert media.

In some cases, the mobile alert application 218 can generate the alert notification to include a user-generated data prompt. The user-generated data prompt may enable a user of the at least one mobile device to input user-generated alert data related to the one of the alert events. For instance, the user-generated data prompt may provide a one-touch interface for a user of mobile device to provide additional user-generated alert data related to the alert event identified in the alert notification. This may facilitate the generation of updated alert data, for instance as a user of mobile device 115 can easily provide additional alert data even while performing other tasks, e.g., driving.

In some cases, the mobile alert application 218 can generate the alert notification to include a user feedback prompt. The user feedback prompt enabling a user of the at least one mobile device to input an alert score indicating an accuracy of the alert notification. For example, the alert score may indicate that the alert location is incorrect (e.g., the event is not occurring in the vicinity of that mobile device 115 or the alert notification was late).

The alert generation server 105 may then update the definition of the corresponding alert event in response to the received alert score. For example, the alert generation server 105 may modify the geographic location code for the alert event in response to the received user feedback.

Referring now to FIG. 6, shown therein is an example of a regional alert notification display 600. As shown in FIG. 6, the regional alert notification display 600 provides a user of mobile device 115 with a map-based display of alerts.

In the example shown, the regional alert notification display 600 shows alert identifiers 605 corresponding to three alert events occurring in the geographic region shown. As shown in FIG. 6, the alert identifiers 605 may provide an indication of the alert type of the alert events shown in regional alert notification display 660.

A user of mobile device 115 has selected one of the alert events 605 and the mobile alert application 118 provides an initial alert event description 610. The regional alert notification display 600 shown by mobile alert application 218 also provides the user with various additional input options 615 enabling the user to provide feedback and/or additional user-generated alert data related to the selected event.

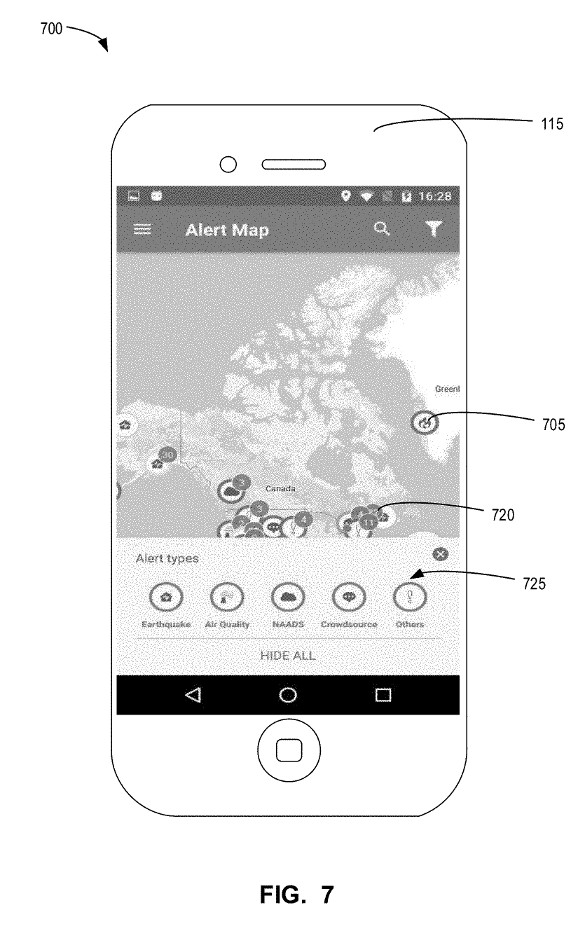

Referring now to FIG. 7, shown therein is another example of a regional alert notification display 700. The regional alert notification display 700 provides a user of mobile device 115 with a map-based display of alerts, but at a much more zoomed-out (i.e. less granular) level.

The regional alert notification display 700 includes a plurality of alert identifiers 705. However, in regional alert notification display 700 a number of alert events are shown in alert clusters 720. A user of the mobile device 115 may then select an alert cluster 720 to navigate to the individual alert events associated with that cluster 720.

The regional alert notification display 700 also includes an alert type selection input interface 725. The alert type selection input interface 725 allows a user of the mobile device 115 to filter the alert event identifiers shown in the regional alert notification display 700 based on the associated alert type. This may allow a user to de-clutter the display 700 by removing alert identifiers related to alert events the user is not interested in.

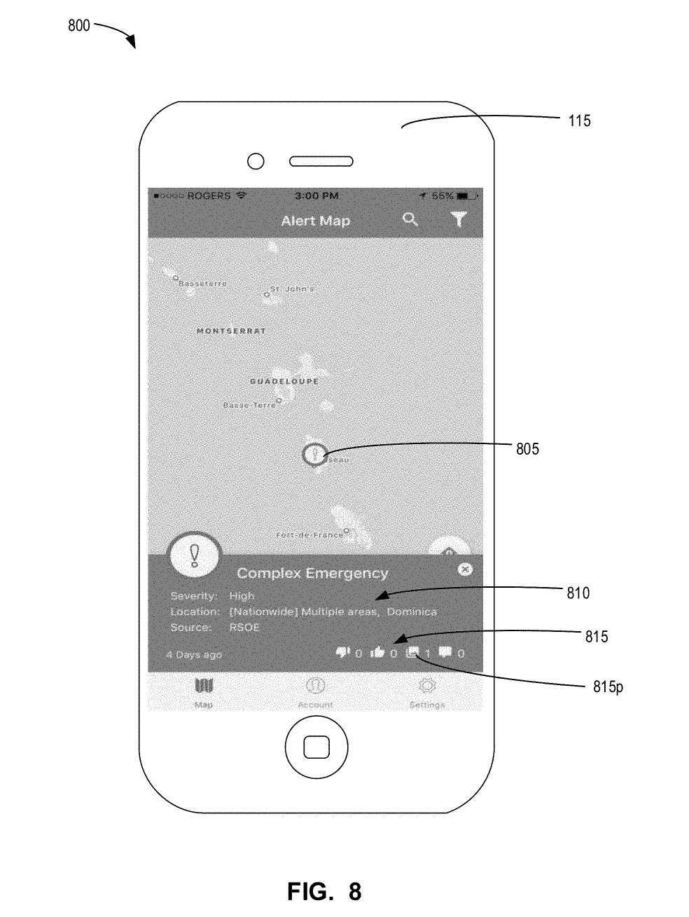

Referring now to FIG. 8, shown therein is an example of an alert notification display 800. Alert notification display 800 is a regional alert notification display similar to display 600 in that a map display is shown including an alert identifier 805. In this case, however, a single alert identifier 805 was generated based on the location of mobile device 115 indicating that a nearby alert event was occurring.

As shown in FIG. 8, an initial alert event description 810 is provided by display 600 identifying the alert event as a complex event. This can indicate to a user that the alert event correspond to multiple alert types. A user may access further information and details regarding the alert event by selecting a portion of the initial alert event description 810. As shown in display 800, the additional input options 815 also provide an indication to the user of additional user-generated alert data and/or user-generated alert media associated with the alert event. For instance, picture input option 815p indicates that a user-generated image has been associated with the alert event by the alert generation server 105.

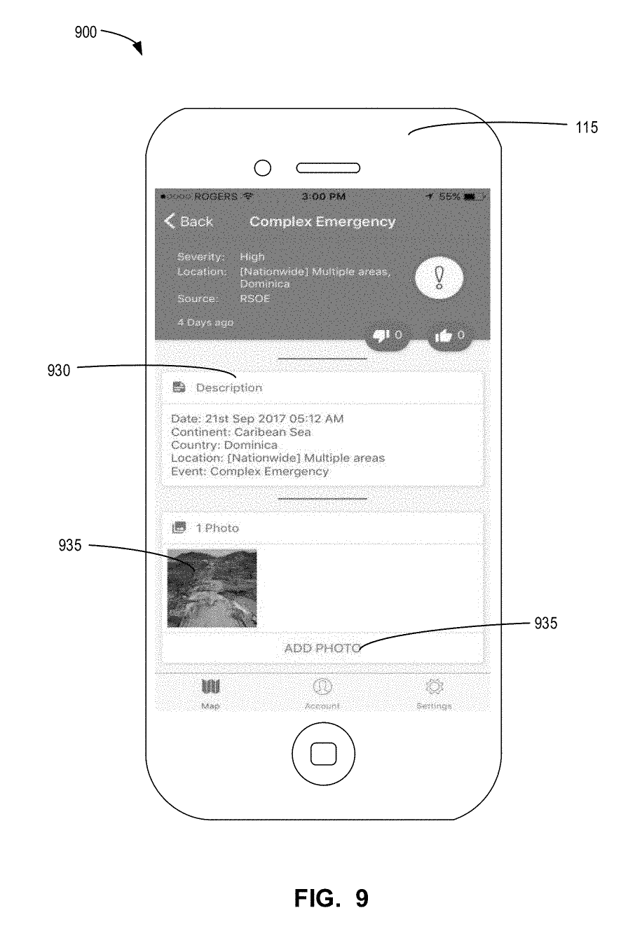

Referring now to FIG. 9, shown therein is an example of a detailed alert event display 900. The detailed alert event display 900 may be shown by mobile alert application 218 in response to a user selecting the alert event description 810.

The detailed alert event display 900 includes an event detail portion 930 providing additional data related to the alert event. The detailed alert event display 900 also provides the user with access to user-generated alert media 935, such as a photo captured by a user of another mobile device 115 while in proximity to the alert event. The user may select the user-generated alert media 935 to initiate a review or playback of the associated media. The detailed alert event display 900 may also include links to external alert data sources, such as the official alert systems associated with an alert event, or additional user-generated data provided through social media platforms such as Twitter® or Facebook®.

The detailed alert event display 900 also includes a user-generated media input 935. A user of the mobile device 115 can select the user-generated media input 935 to provide or capture media related to the alert event. The mobile alert application 218 may initiate the mobile device 115 camera and/or microphone in response to the selected of the user-generated media input 935. The mobile alert application 218 may then transmit the captured alert media to alert generation server 105 to be associated with the alert event and displayed to other users via the mobile alert application 218 operating on their respective mobile devices 115.

Referring now to FIG. 10, shown therein is an example of a user-generated alert interface display 1000. The user-generated alert interface display 1000 is an example of a user interface that may be displayed by mobile alert application 218 to allow a user to input user-generated alert event data. When a user has completed the definition of the alert event data, the mobile alert application 218 can transmit the user-generated alert data to the alert generation server 105 in response to the user selecting a “post” option 1030.

As shown, the user-generated alert interface display 1000 includes an alert type option 1005, an alert severity option 1010, and an alert detail option 1015. The user-generated alert interface display 1000 also includes a user-generated alert media input 1020 that may allow the user of the mobile device 115 to capture alert media to be associated with the alert event. The user-generated alert interface display 1000 also shows that the alert location data 1025 is determined based on the current location of the mobile device 115, using location data generated by the mobile device 115.

Referring now to FIG. 11, shown therein is another example of a user-generated alert interface display 1100. The user-generated alert interface display 1100 provides an example of a user input display in which a plurality of pre-defined alert types 1105 are shown to the user of mobile device 115. The user may then simply select one of the pre-defined alert types 1105 to define the alert type of the user-generated alert event.

Although both FIG. 10 and FIG. 11 illustrate examples of user-generated alert input interfaces that may be operated using an input device such as a touchscreen, the mobile alert application 218 can similarly use voice commands from a user of the mobile device 115 to define the user-generated alert data as mentioned above.

While the above description provides examples of one or more systems or methods, it will be appreciated that other systems or methods may be within the scope of the accompanying claims.

We claim:

1. A system for generating location-based alerts for mobile device users, the system comprising:
an alert generation server in communication with a plurality of official alert systems, the plurality of official alert systems including a plurality of independent alert systems that each monitor one or more types of alert events; and
a plurality of mobile devices in communication with the alert generation server, each mobile device having a mobile alert application operating thereon,
wherein
the alert generation server is configured to:
receive official alert data from the plurality of official alert systems, the official alert data defining a plurality of official alerts;
extract, for each official alert, corresponding alert location information from the received official alert data;
generate an official alert geographic location code for each official alert based on the extracted alert location information;
assign each official alert an official alert type based on the received official alert data, the official alert type defining the type of event indicated by that official alert;
define a plurality of alert events based on the plurality of official alerts using the assigned official alert type and official alert geographic location code generated for each official alert, wherein each alert event has a defined event alert type that corresponds to the official alert type for one or more of the official alerts and a geographic region code that defines a geographic region for the alert event that includes the location identified by the official alert geographic location code for the one or more official alerts, and
at least one mobile device is configured by the mobile alert application operating thereon to:
determine, based on location data from that mobile device, that the mobile device is located within a threshold proximity of the geographic region defined by one of the alert events; and
generate an alert notification for a user of that mobile device, the alert notification identifying the alert event and providing an indication that the mobile device is within the threshold proximity of the geographic region of that alert event.

2. The system of claim 1, wherein the alert generation server is configured to:
receive user-generated alert data from the mobile alert application operating on a particular mobile device in the plurality of mobile devices, the user-generated alert data including a user-generated alert type and alert location data;
define a user-alert geographic location code for the user-generated alert data based on the alert location data; and
define the plurality of alert events using the received user-generated alert data, wherein the alert type defined by the alert generation server for one of the alert events corresponds to the user-generated alert type and the geographic code defined by the alert generation server for the one of the alert events defines a geographic region including the location indicated by the user-alert geographic location code.

3. The system of claim 2, wherein the alert generation server is configured to:
correlate the user-generated alert data with the official alert data by:
comparing the user alert geographic location code with the official alert geographic location codes generated for each of the official alerts; and
comparing the user-generated alert type with the official alert type assigned to each of the official alerts;
determine, based on the correlation, that the user-generated alert data corresponds to an additional alert event; and
define the plurality of alert events to include an additional alert event using the user-generated alert type and user alert geographic location code, wherein the additional alert event has a defined event alert type that corresponds to the user-generated alert type and a geographic region code that defines a geographic region for the additional alert event that includes the location identified by the user alert geographic location code.

4. The system of claim 2, wherein the alert generation server is configured to:
correlate the user-generated alert data with the official alert data by:
comparing the user alert geographic location code with the official alert geographic location codes generated for each of the official alerts; and
comparing the user-generated alert type with the official alert type assigned to each of the official alerts;
determine, based on the correlation, that the user-generated alert data corresponds to a particular alert event in the plurality of alert events; and
update the definition of the particular alert event to include the user alert geographic location code and the user-generated alert type.

5. The system of claim 2, wherein the particular mobile device is configured by the mobile alert application operating thereon to:
define a user input interface on the mobile device that includes a plurality of pre-defined alert types;
receive a user input selecting one of the pre-defined alert types; and
define the user-generated alert type as the selected pre-defined alert type.

6. The system of claim 2, wherein the particular mobile device is configured by the mobile alert application operating thereon to:
receive an alert generation input indicating the creation of the user-generated alert data; and
automatically generate the alert location data in response to the alert generation input by identifying mobile device location data defining a current location of the mobile device.

7. The system of claim 2, wherein the alert generation server is configured to:
receive user-generated alert data from the mobile alert application operating on a plurality of additional mobile devices, the user-generated alert data from each additional mobile device including a corresponding user-generated alert type and corresponding alert location data;
determine that the user-generated alert data received from at least one of the additional mobile devices relates to the same alert event as the user-generated alert data received from the particular mobile device;
determine that the user-generated alert data received from the at least one of the additional mobile devices includes alert location data identifying a location external to the geographic region defined by the geographic region code of that alert event; and
modify the geographic region code of that alert event to include the location defined by the alert location data received from the at least one of the additional mobile devices.

8. The system of claim 1, wherein:
the alert generation server is configured to:
receive user-generated alert data from the mobile alert application operating on a specific mobile device, wherein the user-generated alert data includes user-generated alert media captured by the mobile device; and
associate the user-generated alert media with the alert event related to that received user-generated alert data; and
the at least one mobile device is configured by the mobile alert application operating thereon to generate the alert notification to include a user-generated media prompt, the user-generated media prompt enabling a user of the at least one mobile device to initiate playback of the user-generated alert media associated with that alert event.

9. The system of claim 1, wherein the at least one mobile device is configured by the mobile alert application operating thereon to:
generate the alert notification to include a user-generated data prompt, the user-generated data prompt enabling a user of the at least one mobile device to input user-generated alert data related to the one of the alert events.

10. The system of claim 1, wherein:
the at least one mobile device is configured by the mobile alert application operating thereon to
generate the alert notification to include a user feedback prompt, the user feedback prompt enabling a user of the at least one mobile device to input an alert score indicating an accuracy of the alert notification; and
transmit the alert score to the alert generation server; and
the alert generation server is configured to update the definition of the one of the alert events in response to receiving the alert score.

11. The system of claim 1, wherein the alert generation server is configured to, for each of at least one of the official alerts:
extract alert location information from the received official alert data by
determining that the official alert data received from the official alert system corresponding to that official alert includes text data describing an associated alert location; and
extracting the identified text data; and
generate the official alert geographic location code by correlating the extracted text data with a corresponding geo-code.

12. A method of generating location-based alerts for mobile device users using an alert generation server in communication with a plurality of official alert systems, each official alert system monitoring one or more types of alert events, the method comprising:
providing a mobile alert application to a plurality of mobile devices in communication with the alert generation server;
receiving, by the alert generation server, official alert data from the plurality of official alert systems, the official alert data defining a plurality of official alerts;
extracting, by the alert generation server for each official alert, corresponding alert location information from the received official alert data;
generating, by the alert generation server, an official alert geographic location code for each official alert based on the extracted alert location information;
assigning, by the alert generation server, each official alert an official alert type based on the received official alert data, the official alert type defining the type of event indicated by that official alert;
defining, by the alert generation server, a plurality of alert events based on the plurality of official alerts using the assigned official alert type and official alert geographic location code generated for each official alert, wherein each alert event has a defined event alert type that corresponds to the official alert type for one or more of the official alerts and a geographic region code that defines a geographic region for the alert event that includes the location identified by the official alert geographic location code for the one or more official alerts;
determining, by the mobile alert application operating on one of the mobile devices based on location data from that mobile device, that the mobile device is located within a threshold proximity of the geographic region defined by one of the alert events; and
generating, by the mobile alert application operating on that mobile device, an alert notification for a user of that mobile device, the alert notification identifying the alert event and providing an indication that the mobile device is within the threshold proximity of the geographic region of that alert event.

13. The method of claim 12, further comprising:
receiving, by the alert generation server, user-generated alert data from the mobile alert application operating on a particular mobile device in the plurality of mobile devices, the user-generated alert data including a user-generated alert type and alert location data;
defining, by the alert generation server, a user-alert geographic location code for the user-generated alert data based on the alert location data; and
defining, by the alert generation server, the plurality of alert events using the received user-generated alert data, wherein the alert type defined by the alert generation server for one of the alert events corresponds to the user-generated alert type and the geographic code defined by the alert generation server for the one of the alert events defines a geographic region including the location indicated by the user-alert geographic location code.

14. The method of claim 13, further comprising:
correlating, by the alert generation server, the user-generated alert data with the official alert data by:
comparing the user alert geographic location code with the official alert geographic location codes generated for each of the official alerts; and
comparing the user-generated alert type with the official alert type assigned to each of the official alerts;
determining, by the alert generation server based on the correlation, that the user-generated alert data corresponds to an additional alert event; and
defining, by the alert generation server, the plurality of alert events to include an additional alert event using the user-generated alert type and user alert geographic location code, wherein the additional alert event has a defined event alert type that corresponds to the user-generated alert type and a geographic region code that defines a geographic region for the additional alert event that includes the location identified by the user alert geographic location code.

15. The method of claim 13, further comprising:
correlating, by the alert generation server, the user-generated alert data with the official alert data by:
comparing the user alert geographic location code with the official alert geographic location codes generated for each of the official alerts; and
comparing the user-generated alert type with the official alert type assigned to each of the official alerts;
determining, by the alert generation server based on the correlation, that the user-generated alert data corresponds to a particular alert event in the plurality of alert events; and
updating the definition of the particular alert event to include the user alert geographic location code and the user-generated alert type.

16. The method of claim 13, further comprising:
defining, by the mobile alert application operating on that mobile device, a user input interface on the mobile device that includes a plurality of pre-defined alert types;
receiving, by the mobile alert application operating on that mobile device, a user input selecting one of the pre-defined alert types; and
defining, by the mobile alert application operating on that mobile device, the user-generated alert type as the selected pre-defined alert type.

17. The method of claim 13, further comprising:
receiving, by the mobile alert application operating on that mobile device, an alert generation input indicating the creation of the user-generated alert data; and
automatically generating, by the mobile alert application operating on that mobile device, the alert location data in response to the alert generation input by identifying mobile device location data defining a current location of the mobile device.

18. The method of claim 13, further comprising:
receiving, by the alert generation server, user-generated alert data from the mobile alert application operating on a plurality of additional mobile devices, the user-generated alert data from each additional mobile device including a corresponding user-generated alert type and corresponding alert location data;
determining, by the alert generation server, that the user-generated alert data received from at least one of the additional mobile devices relates to the same alert event as the user-generated alert data received from the particular mobile device;
determining, by the alert generation server, that the user-generated alert data received from the at least one of the additional mobile devices includes alert location data identifying a location external to the geographic region defined by the geographic region code of that alert event; and
modifying the geographic region code of that alert event to include the location defined by the alert location data received from the at least one of the additional mobile devices.

19. The method of claim 12, further comprising:
receiving, by the alert generation server, user-generated alert data from the mobile alert application operating on a specific mobile device, wherein the user-generated alert data includes user-generated alert media captured by the mobile device;
associating, by the alert generation server, the user-generated alert media with the alert event related to that received user-generated alert data; and
generating, by the mobile alert application operating on the mobile device, the alert notification to include a user-generated media prompt, the user-generated media prompt enabling a user of the at least one mobile device to initiate playback of the user-generated alert media associated with that alert event.

20. The method of claim 12, further comprising:
generating, by the mobile alert application operating on the mobile device, the alert notification to include a user-generated data prompt, the user-generated data prompt enabling a user of the at least one mobile device to input user-generated alert data related to the one of the alert events.

21. The method of claim 12, further comprising:
generating, by the mobile alert application operating on the mobile device, the alert notification to include a user feedback prompt, the user feedback prompt enabling a user of the at least one mobile device to input an alert score indicating an accuracy of the alert notification;
transmitting the alert score to the alert generation server; and
updating, by the alert generation server, the definition of the one of the alert events in response to receiving the alert score.

22. The method of claim 12, further comprising, for each of at least one of the official alerts:
extracting, by the alert generation server, alert location information from the received official alert data by
determining that the official alert data received from the official alert system corresponding to that official alert includes text data describing an associated alert location; and
extracting the identified text data; and
generating the official alert geographic location code by correlating the extracted text data with a corresponding geo-code.
